(19) United States
(12) Patent Application Publication
(10) Pub. No.: US 2025/0050519 A1
(43) Pub. Date: Feb. 13, 2025

(54) OUTER NET BLADE MEMBER, OUTER NET BLADE USING OUTER NET BLADE MEMBER, AND ELECTRIC RAZOR PROVIDED WITH OUTER NET BLADE

(71) Applicant: Panasonic Intellectual Property Management Co., Ltd., Osaka (JP)

(72) Inventors: SATOSHI UCHIDA, Shiga (JP); ATSUTAKA IKEMOTO, Shiga (JP); SHUNSUKE KOMORI, Shiga (JP); YOSHIHARU HAYASHI, Shiga (JP); HIROKI OSHIMA, Shiga (JP)

(21) Appl. No.: 18/760,094

(22) Filed: Jul. 1, 2024

(30) Foreign Application Priority Data
Aug. 8, 2023 (JP) 2023-129175

(51) Int. Cl. B26B 19/38

(52) U.S. Cl. CPC B26B 19/384

(57) ABSTRACT

The present disclosure provides an outer net blade member capable of forming an outer net blade capable of shaving hair more efficiently, the outer net blade formed using the outer net blade member, and an electric razor including the outer net blade. The outer net blade member according to the present disclosure is capable of forming the outer net blade provided on the electric razor. The outer net blade member includes a cuttable region in which multiple blade holes each in a substantially hexagonal shape are formed in rows in a first direction and a second direction orthogonal to the first direction. The blade holes are formed in a state of forming a row in the second direction in which the blade holes adjacent to each other in the second direction are shifted from each other in position in the first direction. At any position between one end and other end in the first direction in the cuttable region, the outer net blade member is formed such that at least one of the blade holes exists within a distance of five rows of the blade holes in the second direction.

### BACKGROUND

### 1. Technical Field

The present disclosure relates to an outer net blade member, an outer net blade formed using the outer net blade member, and an electric razor including the outer net blade.

### 2. Description of the Related Art

As disclosed in PTL 1, an outer net blade used for an electric razor that shaves hair such as a whisker has been conventionally known. PTL 1 shows the outer net blade that is formed using an outer net blade member in the shape of a long plate shape. Specifically, the outer net blade is formed by curving the outer net blade member in its latitudinal direction in such a way that the outer net blade member protrudes upward, the outer net blade member including multiple blade holes that are each defined as a substantially hexagonal shape by bars and that are formed in a mesh shape.

The outer net blade member formed into the outer net blade after being bent in the latitudinal direction and protruded upward is attached to a razor body. In this way, an electric razor including the outer net blade with blade holes that are formed in a mesh shape is formed.

### CITATION LIST

### Patent Literature

PTL 1: Unexamined Japanese Patent Publication No. 2010-099493

### SUMMARY

As described above, when an outer net blade is formed using an outer net blade member provided with blade holes that are each in a substantially hexagonal shape and that are formed in a mesh shape, the outer net blade with which hair can be shaped more efficiently is preferably formed.

Thus, it is an object of the present disclosure to acquire an outer net blade member capable of forming an outer net blade with which hair can be shaped more efficiently, the outer net blade formed using the outer net blade member, and an electric razor including the outer net blade.

An outer net blade member according to an aspect of the present disclosure is capable of forming an outer net blade provided on an electric razor. The outer net blade member includes a cuttable region capable of cutting hair in a state where the outer net blade is provided on the electric razor. The cuttable region includes multiple blade holes that are each defined as a substantially hexagonal shape by bars and that are formed while forming a row not only in a first direction but also in a second direction orthogonal to the first direction. The first direction is a direction in which an inner net blade moves relative to the outer net blade when the outer net blade is provided on the electric razor. The second direction is a direction of shaving when the outer net blade is provided on the electric razor. The blade holes are formed in a state of forming a row in the second direction in which blade holes adjacent to each other are shifted from each other in position in the first direction. At any position between one end and the other end in the first direction in the cuttable region, at least one of the blade holes exists within a distance of five rows of the blade holes in the second direction.

An outer net blade according to an aspect of the present disclosure is formed by using the outer net blade member.

An electric razor according to an aspect of the present disclosure includes the outer net blade.

The present disclosure provides an outer net blade member capable of forming an outer net blade with which hair can be shaved more efficiently, the outer net blade formed using the outer net blade member, and an electric razor including the outer net blade.

### BRIEF DESCRIPTION OF THE DRAWINGS

FIG. 1 is a front view illustrating an example of an electric razor according to an exemplary embodiment;

FIG. 2 is a partially exploded front view illustrating an example of the electric razor according to the exemplary embodiment;

FIG. 3 is a perspective view illustrating another example of an outer blade cassette according to the exemplary embodiment;

FIG. 4 is a perspective view illustrating another example of the outer blade cassette according to the exemplary embodiment in a state where a part of the outer-blade cassette is cut;

FIG. 5 is a plan view illustrating an example of the outer net blade member according to the exemplary embodiment;

FIG. 6 is an enlarged view illustrating a blade hole part formed in an example of the outer net blade member according to the exemplary embodiment;

FIG. 7 is a further enlarged view illustrating a blade hole part formed in an example of the outer net blade member according to the exemplary embodiment; and

FIG. 8 is a cross-sectional view illustrating thicknesses of a first bar, a second bar, and a third bar provided in an example of the outer net blade member according to the exemplary embodiment.

### DETAILED DESCRIPTIONS

Hereinafter, an exemplary embodiment will be described in detail with reference to drawings. However, detailed description more than necessary may not be described. For example, a detailed description of already well-known matters or a duplicated description of a substantially identical configuration may not be described.

The accompanying drawings and the following description are only presented to help those skilled in the art fully understand the present disclosure and are not intended to limit the subject matters described in the scope of claims.

When an electric razor is described in the following exemplary embodiment, a direction in which a plurality of blade blocks is arranged side by side is referred to as an X-direction, and a direction in which each blade block extends is referred to as a Y-direction. The X-direction herein may be also referred to as a front-back direction or a direction of shaving. The Y-direction herein may be also referred to as a left-right direction. The Y-direction is a direction in which an inner net blade moves relative to an outer net blade.

Additionally, an up-down direction in a state where a head cover (i.e., one element of the electric razor) is disposed such that a skin contact surface faces upward is described as a Z-direction (i.e., the up-down direction). In the present exemplary embodiment, a skin contact surface of a blade unit is formed of surfaces (more specifically, outer surfaces) of outer blades of the multiple blade blocks, and that can be approximated by a curved surface protruding outward as a whole. Thus, in the following exemplary embodiment, a state in which a head part (i.e., an example of a body part) is disposed such that the skin contact surface faces upward is described as a state where a point protruding outermost from the curved surface approximate to the skin contact surface of the blade unit is located at an uppermost part and where a contact plane at the point protruding outermost from the curved surface approximate to the skin contact surface of the blade unit is a horizontal plane.

In the following exemplary embodiment, a side where a power supply switch of the electric razor is provided is described as a front side in the X-direction.

When an outer net blade member is described in the following exemplary embodiment, a latitudinal direction of the outer net blade member is referred to as the X-direction (i.e., a second direction, more specifically, a direction to be a direction of shaving), a longitudinal direction of the outer net blade member is referred to as the Y-direction (i.e., a first direction, more specifically, a direction in which the inner net blade moves relative to the outer net blade), and a thickness direction of the outer net blade member is referred to as the Z-direction (i.e., a plate thickness direction). In the following exemplary embodiment, the X-direction of the outer net blade member corresponds to the X-direction of the electric razor provided with the outer net blade, and the Y-direction of the outer net blade member corresponds to the Y-direction of the electric razor provided with the outer net blade.

### EXEMPLARY EMBODIMENT

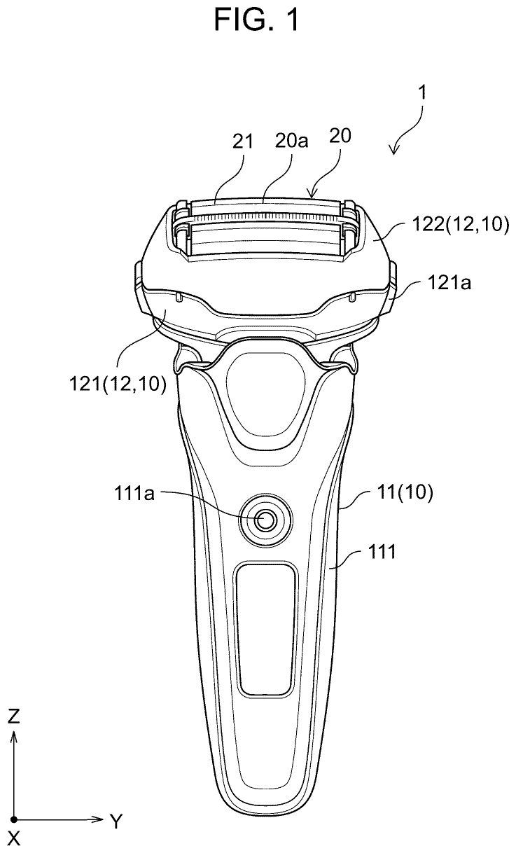

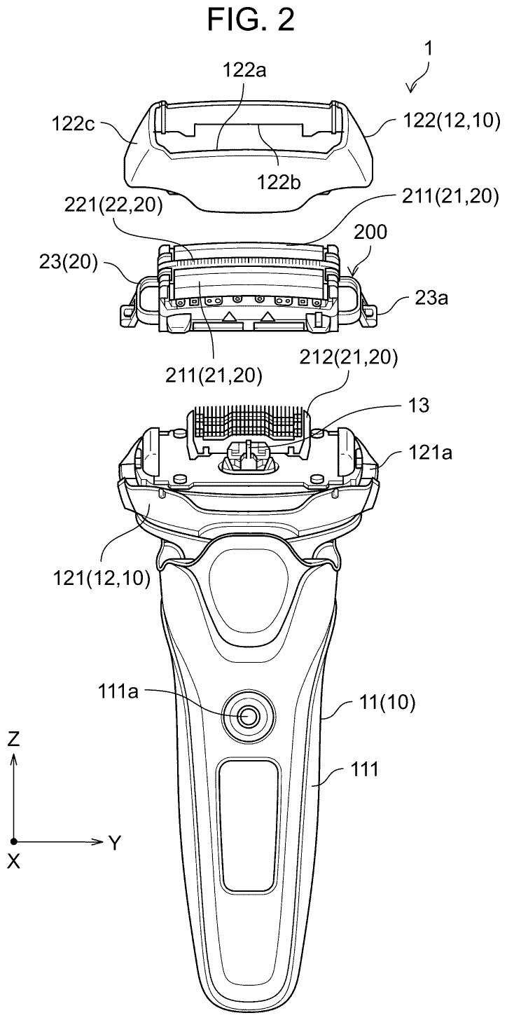

First, a configuration of electric razor 1 will be described with reference to FIGS. 1 and 2.

FIG. 1 is a front view schematically illustrating an example of electric razor 1 according to the exemplary embodiment. FIG. 2 is a partially exploded front view illustrating an example of electric razor 1 according to the exemplary embodiment. As illustrated in FIGS. 1 and 2, electric razor 1 according to the present exemplary embodiment includes: razor body 10; and blade unit 20 that is held by razor body 10 in a state where skin contact surface 20a (i.e., a surface of an outer blade of each blade block, which will be described later) is exposed.

Razor body 10 includes grip part 11 that can be held by hand, and head part 12 supported by grip part 11. In the present exemplary embodiment, head part 12 is supported by grip part 11 in a state where head part 12 is inclined upward and forward and where an extension direction of grip part 11 substantially corresponds to the up-down direction.

Head part 12 can be swung in the Y-direction with respect to grip part 11 about a shaft part (not illustrated) extending in the X-direction as an axis. Head part 12 can also be swung in the X-direction with respect to grip part 11 about a shaft part (not illustrated) extending in the Y-direction as an axis. Head part 12 further can float in the Z-direction with respect to grip part 11.

These swing and float mechanisms can be appropriately combined to form another configuration. For example, head part 12 may be configured not only to be swingable in the X-direction and the Y-direction with respect to grip part 11 but also to float in the Z-direction with respect to grip part 11.

Head part 12 may be configured not to swing or float with respect to grip part 11. Head part 12 may be configured not to be inclined with respect to grip part 11.

Grip part 11 includes a body housing 111, a cavity is formed inside of body housing 111. The cavity provided inside body housing 111 houses various electric components such as a rechargeable battery.

Power supply switch 111a of a press type (i.e., power supply switch 111a for turning on and off a power supply of electric razor 1) for operating electric razor 1 is formed on power supply switch 111a. Although the present exemplary embodiment exemplifies the switch of a press type as power supply switch 111a, another switch such as a switch of a slide type may be used as long as the switch can turn on and off the power supply.

In the present exemplary embodiment, power supply switch 111a is formed on a front surface of body housing 111, that is, on a front surface (i.e., a front of electric razor 1) of electric razor 1. The front surface of electric razor 1 refers to a surface facing a user in a state where the user grips grip part 11 of electric razor 1 in normal use.

A trimmer unit may be provided at a rear part of body housing 111 (i.e., at a rear part of electric razor 1).

Head part 12 includes head part body 121 attached to grip part 11 and head cover 122 which is detachably attached to head part body 121. In the present embodiment, when release buttons 121a provided on left and right ends of head part body 121 in a retractable manner are retracted inward, attachment between head cover 122 and head part body 121 is released.

Head part body 121 internally houses a drive mechanism. The drive mechanism includes a plurality of drive poles 13, and is housed in head part body 121 in a state where drive poles 13 protrude upward from head part body 121. As such a drive mechanism, conventionally known available examples include a linear actuator of a vibration type, and a drive mechanism including a rotary motor and a conversion mechanism that converts rotational motion into reciprocating linear motion.

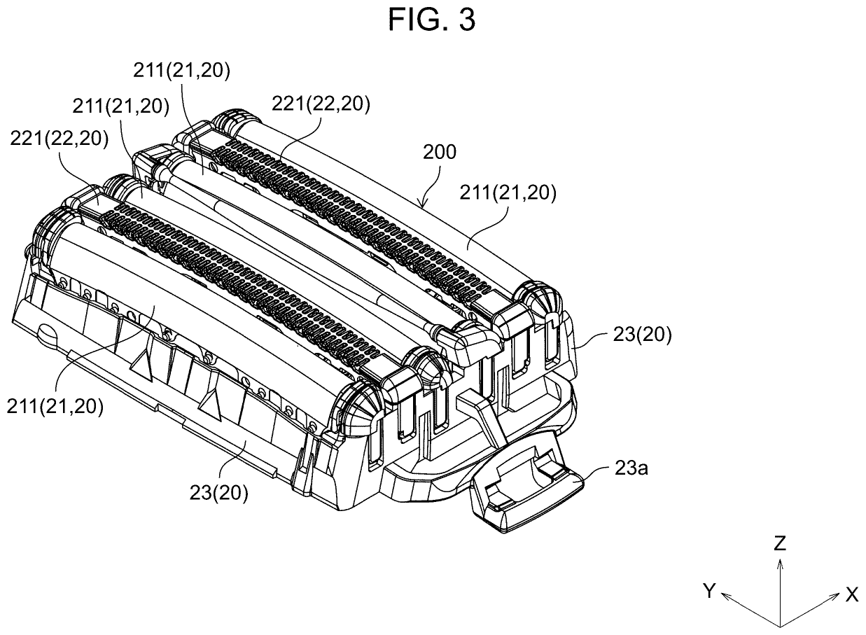

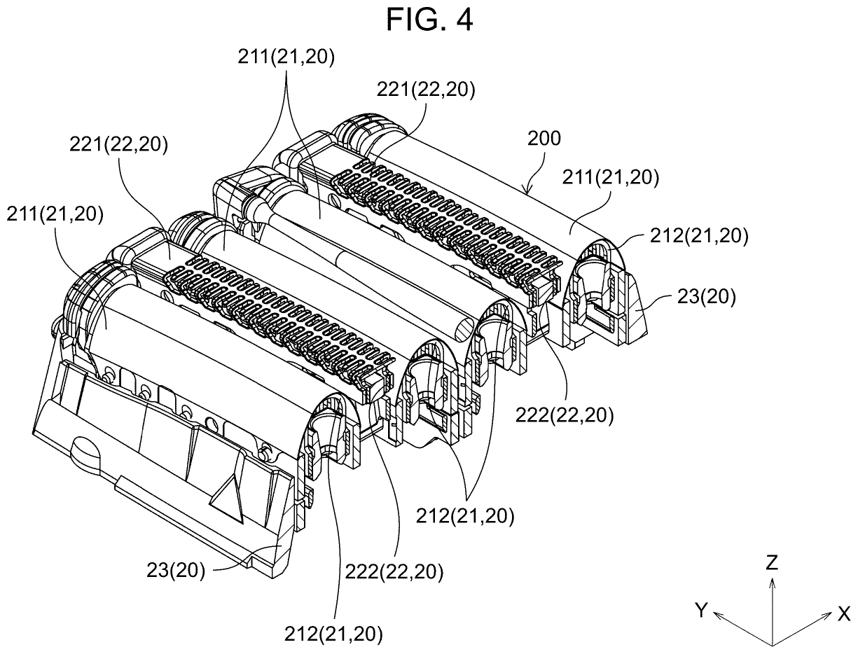

FIG. 3 is a perspective view illustrating another example of outer blade cassette 200 according to the exemplary embodiment. FIG. 4 is a perspective view illustrating the example of outer blade cassette 200 according to the exemplary embodiment in a state where a part of outer blade cassette 200 is cut. Available examples of a blade unit include blade unit 20 illustrated in FIG. 2, and blade unit 20 illustrated in FIGS. 3 and 4. Blade unit 20 illustrated in FIG. 2 includes three blade blocks and outer blade case 23, and the three blade blocks are disposed side by side in the X-direction in a state where the longitudinal directions the thereof corresponds to the Y-direction. In contrast, blade unit 20 illustrated in FIGS. 3 and 4 includes six blade blocks and outer blade case 23, and the six blade blocks are disposed side by side in the X-direction in a state where the longitudinal directions there of corresponds to the Y-direction.

As described above, in the present exemplary embodiment, each of the blade blocks has a predetermined length and width. The blade blocks are disposed in a state where the length direction there of substantially corresponds to the Y-direction (i.e., the first direction and the left-right direction) of electric razor 1, and where the width direction there of substantially corresponds to the X-direction (i.e., the second direction, the front-back direction, and the direction of shaving) of electric razor 1.

Blade unit 20 illustrated in FIG. 2 includes the three blade blocks composed of two net blade blocks 21 and one slit blade block 22. In contrast, blade unit 20 illustrated in FIGS. 3 and 4 is composed of four net blade blocks 21 and two slit blade blocks 22.

Net blade block 21 mainly has a function of cutting off whisker H (i.e., an example of hair) in a fallen state and whisker H in a short standing state (i.e., an example of hair). Slit blade block 22 mainly has a function of cutting off thin long whisker H (i.e., an example of hair). An example of hair is body hair.

Blade unit 20 illustrated in FIG. 2 includes one slit blade block 22 disposed at the center in the X-direction, and two net blade blocks 21 disposed on respective sides across slit blade block 22. Blade unit 20 illustrated in FIGS. 3 and 4 includes two net blade blocks 21 disposed in a central part in the X-direction, and two slit blade blocks 22 disposed on respective sides across net blade blocks 21 in the central part. Other two net blade blocks 21 are disposed adjacent to corresponding slit blade blocks 22.

As illustrated in FIGS. 2 to 4, net blade block 21 includes outer net blade 211 and inner net blade 212. In the present exemplary embodiment, outer net blade 211 is formed by being curved in an inverted U-shape convex upward in a side view (i.e., in a state viewed in the Y-direction). Outer net blades 211 each can be formed with a substantially equal radius of curvature (i.e., a radius of curvature of the part curved in the inverted U-shape), or outer net blades 211 can be formed including at least one outer net blade 211 having a different radius of curvature.

Outer net blade 211 is also formed by being slightly curved in the Y-direction (i.e., outer blade length direction) to be convex upward in front view (i.e., in a state viewed in the X-direction). Outer net blade 211 is formed in which many blade holes 33 each in a substantially hexagonal shape are spread. Outer net blade 211 may be formed without being curved to be convex upward in front view. For example, when outer net blade 211 is viewed from the front (i.e., in a state viewed in the X-direction), the top of outer net blade 211 may be a straight line extending in the Y-direction (i.e., outer blade length direction).

Inner net blade 212 has an inverted U-shape along a curved shape of outer net blade 211, and is disposed inside outer net blade 211 (i.e., below outer net blade 211, more specifically, on a reverse surface of a surface of outer net blade 211 in contact with skin). Inner net blade 212 is detachably attached to one drive pole 13 of multiple drive poles 13. When a power supply of electric razor 1 is turned on to drive pole 13 in a state where inner net blade 212 is attached to drive pole 13, and disposed inside outer net blade 211, inner net blade 212 is displaced relative to outer net blade 211 (that is, is relatively moved, more specifically, is reciprocated in the Y-direction) while being in sliding contact with an inner surface of outer net blade 211.

As illustrated in FIG. 4, slit blade block 22 includes outer slit blade 221 and inner slit blade 222. In the present exemplary embodiment, outer slit blade 221 is formed by being bent in an inverted U-shape convex upward in the side view (i.e., in a state viewed in the Y-direction).

Further, outer slit blade 221 is formed by being slightly curved in the Y-direction (i.e., outer blade length direction) to be convex upward in front view (i.e., in a state viewed in the X-direction). Outer slit blade 221 is provided with multiple blade holes that are each in a slit shape extending in the X-direction and are spaced apart from each other in the Y-direction. Outer slit blade 221 may be formed without being curved to be convex upward in front view. For example, when outer slit blade 221 is viewed from the front (i.e., when viewed in the X-direction), the top of outer slit blade 221 may be a straight line extending in the Y-direction (i.e., outer blade length direction). That is, outer slit blade 221 can be formed such that the top surface of outer slit blade 221 is a plane (i.e., a flat surface).

As illustrated in FIG. 4, inner slit blade 222 has an inverted U-shape along a bent shape of outer slit blade 221, and is disposed inside outer slit blade 221 (i.e., below outer slit blade 221, more specifically, on the reverse surface of the surface of outer slit blade 221 in contact with skin). Inner slit blade 222 is detachably attached to one drive pole 13 of multiple drive poles 13 (more specifically, drive pole 13 different from the drive pole to which inner net blade 212 is attached). When the power supply of electric razor 1 is turned on to drive pole 13 in a state where inner slit blade 222 is attached to drive pole and where inner slit blade 222 is disposed inside outer slit blade 221, inner slit blade 222 is displaced relative to outer slit blade 221 (that is, is relatively moved, more specifically, is reciprocated in the Y-direction) while being in sliding contact with an inner surface of outer slit blade 221.

As described above, electric razor 1 according to the present exemplary embodiment has a form of a reciprocating electric razor in which inner net blade 212 and inner slit blade 222 are reciprocated with respect to outer net blade 211 and outer slit blade 221, respectively.

In blade unit 20 illustrated in FIG. 2, members other than two inner net blades 212 in the three blade blocks are mounted on outer blade case 23 which is in a substantially frame shape. At this time, each of the members may be detachably attached to outer blade case 23, or may be attached to outer blade case 23 in a state of being undetachable.

Two net blade blocks 21 and one slit blade block 22 are attached to outer blade case 23 in a state of being floatable in the Z-direction (i.e., the up-down direction). In this way, each blade block is allowed to be floated separately and independently from head part 12 (i.e., an example of the body part) when head cover 122 to which outer blade cassette 200 has been attached is attached to head part body 121. As a result, outer blades (more specifically, skin contact surface 20a of blade unit 20) can be more reliably brought into contact with skin along a shape of the skin, so that whisker H (i.e., an example of hair) can be more reliably cut.

The multiple blade blocks may include at least one blade block that is held in head part 12 (i.e., an example of the body part) in a non-floatable state.

In the present exemplary embodiment, as illustrated in FIG. 2, two outer net blades 211 are mounted on outer blade case 23 in a state where inner net blades 212 are not disposed inward, and one outer slit blade 221 is mounted on outer blade case 23 in a state where inner slit blades are disposed inward. As described above, in blade unit 20 illustrated in FIG. 2, outer blade cassette 200 is formed by attaching two outer net blades 211 and one slit blade block 22 to outer blade case 23. Outer blade cassette 200 is detachably attached to head cover 122.

Specifically, head cover 122 includes peripheral wall part 122c in a substantially hollow-columnar shape provided with upper opening 122a and lower opening 122b. Outer blade cassette 200 in which each outer blade faces upward is inserted from below lower opening 122b of head cover 122 to mount outer blade cassette 200 on head cover 122. At this time, outer blade cassette 200 is attached to head cover 122 in a state where a surface of each outer blade is exposed from upper opening 122a of head cover 122. Thus, in the present exemplary embodiment, a part of the surface of each outer blade, the part being exposed from upper opening 122a of head cover 122, serves as skin contact surface 20a that comes into contact with skin (i.e., a skin surface) of the user.

Outer blade case 23 is provided at its left and right ends with release buttons 23a, and release buttons 23a are operated to release attachment between head cover 122 and outer blade cassette 200.

As described above, blade unit 20 illustrated in FIG. 2 is configured such that head cover 122 to which outer blade cassette 200 has been attached is attached to head part body 121 in a state where two inner net blades 212 are attached to corresponding drive poles 13 protruding upward from head part body 121. When head cover 122 to which outer blade cassette 200 has been attached is attached to head part body 121 in a state where two inner net blades 212 are attached to corresponding drive poles 13, two inner net blades 212 are disposed inside corresponding outer net blades 211.

In this way, each inner blade is allowed to be displaced relatively (i.e., relatively moved, more specifically, reciprocated in the Y-direction) to the corresponding outer blade, when the power supply of electric razor 1 is turned on.

In contrast, in blade unit 20 illustrated in FIGS. 3 and 4, all of the six blade blocks are mounted on outer blade case 23 in a substantially frame shape. At this time, each of the members may be detachably attached to outer blade case 23, or may be attached to outer blade case 23 in a state of being undetachable.

Four net blade blocks 21 and two slit blade blocks 22 are attached to outer blade case 23 in a state of being floatable in the Z-direction (i.e., the up-down direction). In this way, each blade block is allowed to be floated separately and independently from head part 12 (i.e., an example of the body part) when head cover 122 to which outer blade cassette 200 has been attached is attached to head part body 121. As a result, outer blades (more specifically, skin contact surface 20a of blade unit 20) can be more reliably brought into contact with skin along a shape of the skin, so that whisker H (i.e., an example of hair) can be more reliably cut.

The multiple blade blocks may include at least one blade block that is held in head part 12 (i.e., an example of the body part) in a non-floatable state.

Blade unit 20 illustrated in FIGS. 3 and 4 is configured such that four net blade blocks 21 are all mounted on outer blade case 23 in a state where inner net blades 212 are disposed inward of corresponding outer net blades 211, and two slit blade blocks 22 are all mounted on outer blade case 23 in a state where inner slit blades 222 are disposed inward of corresponding outer slit blades 221. As described above, in blade unit 20 illustrated in FIGS. 3 and 4, outer blade cassette 200 is formed by attaching four net blade blocks 21 and two slit blade blocks 22 to outer blade case 23.

Outer blade cassette 200 is detachably attached to head cover 122.

In this way, each inner blade is allowed to be displaced relative to the corresponding outer blade (i.e., relatively moved, more specifically, reciprocated in the Y-direction), when the power supply of electric razor 1 is turned on.

While the power supply of electric razor 1 is turned on and each inner blade is displaced relative to the corresponding outer blade, skin contact surface 20a of blade unit 20 is brought into contact with the skin of the user (i.e., the skin surface) and is moved while being slid in the X direction, thereby cutting whisker H (i.e., an example of hair) inserted into the blade hole of each outer blade using the outer blade and the inner blade.

As described above, in the present exemplary embodiment, head part 12 corresponds to a body part that holds blade unit 20 in a state where skin contact surface 20a is exposed.

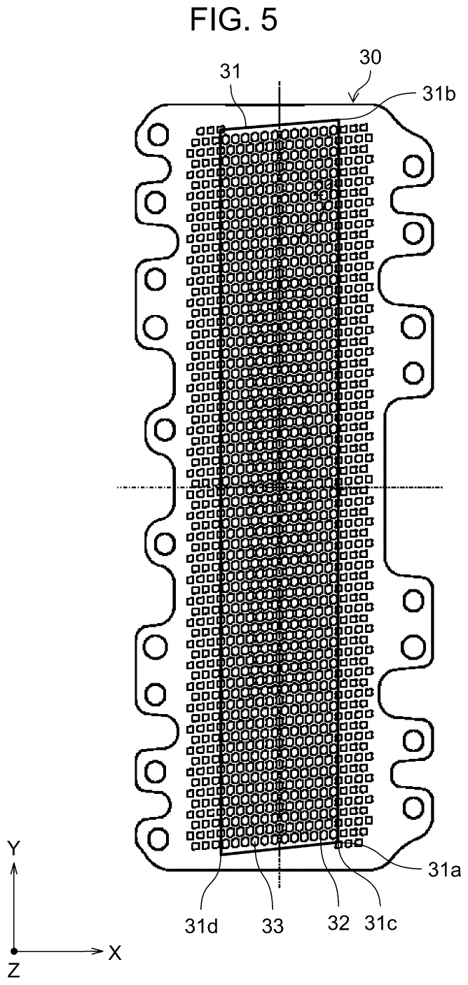

Next, a configuration of outer net blade member 30 used for forming outer net blade 211 according to the present exemplary embodiment will be described with reference to FIGS. 5 to 8.

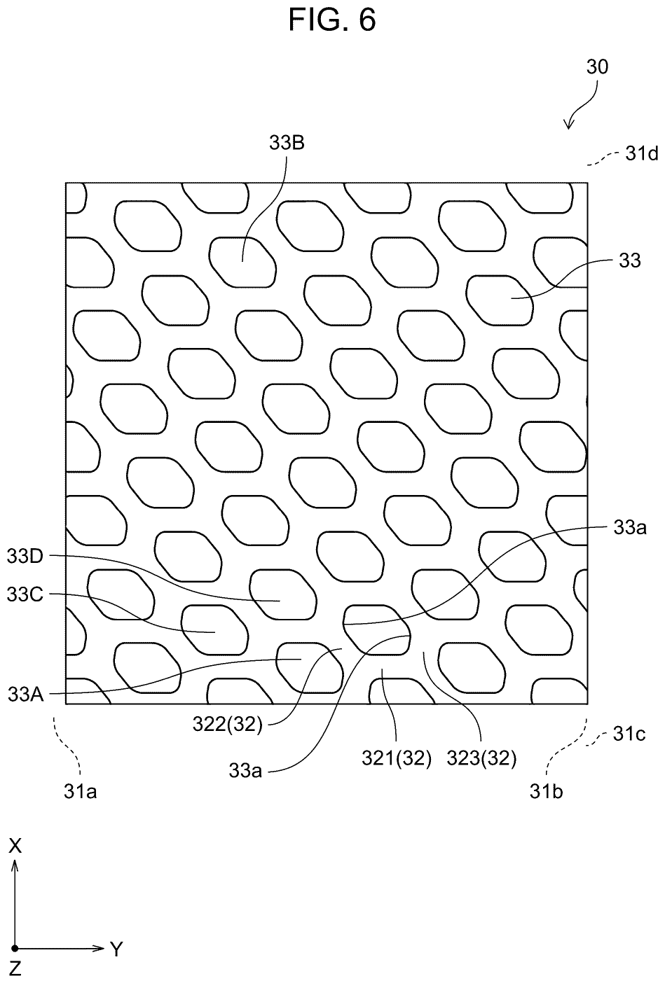

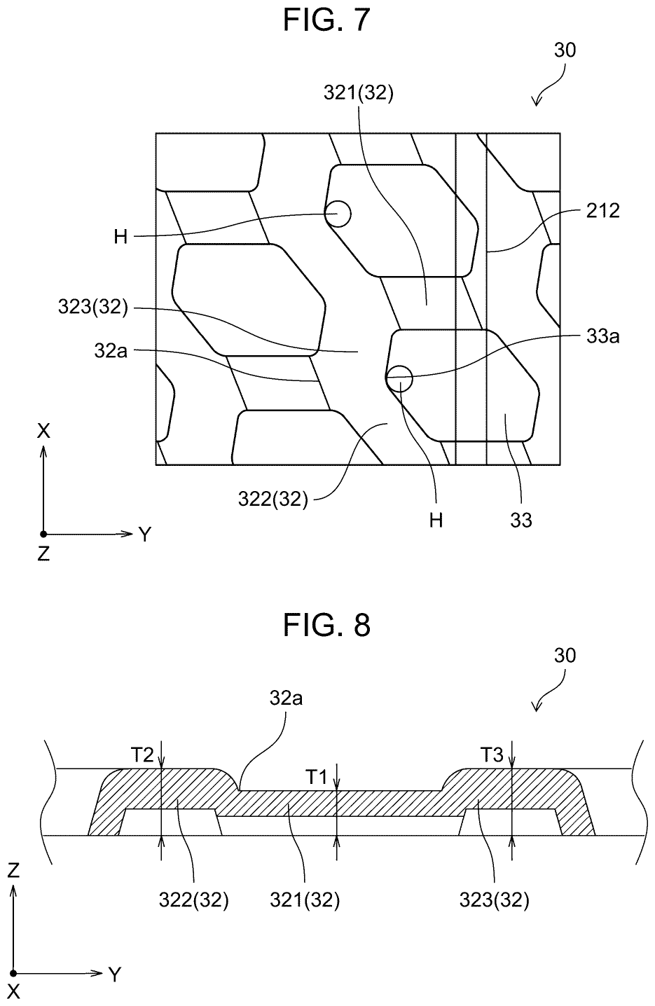

FIG. 5 is a plan view illustrating an example of outer net blade member 30 according to the exemplary embodiment. FIG. 6 is an enlarged view illustrating a part of blade hole 33 formed in the example of outer net blade member 30 according to the exemplary embodiment. FIG. 7 is a further enlarged view illustrating the part of blade hole 33 formed in the example of outer net blade member 30 according to the exemplary embodiment. FIG. 8 is a cross-sectional view illustrating thicknesses of first bar 321, second bar 322, and third bar 323 provided in the example of outer net blade member 30 according to the exemplary embodiment. As illustrated in FIG. 5, outer net blade member 30 has a substantially rectangular plate shape, and is provided on its outer peripheral edge part with a fixing part for being fixed to an outer blade holder attached to outer blade case 23. In a state where outer net blade member 30 is bent in an inverted U-shape convex upward in a view in the longitudinal direction, the fixing part formed on outer net blade member 30 is fixed to a fixing member such as an outer blade joint to form outer net blade 211. Alternatively, outer net blade member 30 bent in an inverted U-shape convex upward in a view in the longitudinal direction may be directly fixed to body housing 111 (i.e., one element of razor body 10) to form electric razor 1 including outer net blade 211.

As described above, outer net blade member 30 is a member used for forming outer net blade 211. In other words, outer net blade member 30 is a material for forming outer net blade 211. Outer net blade member 30, which is a material for forming outer net blade 211, is fixed to the fixing member such as the outer blade joint or body housing 111 in a curved state to allow a part of a curved part to function as outer net blade 211.

Specifically, when a central part of outer net blade member 30 is curved in the X-direction (i.e., the second direction, more specifically, a direction to be the direction of shaving) to be convex upward to form outer net blade 211, the central part serves as a region in which inner net blade 212 is in sliding contact with outer net blade 211. That is, the central part of outer net blade member 30 serves as a region exposed to the outside when outer net blade 211 is attached to electric razor 1, so that the region serves to enable whisker H (i.e., an example of hair) to be cut by outer net blades 211 and inner net blades 212 by bringing skin into contact with the region.

As described above, in the present exemplary embodiment, cuttable region 31, which is a region where whisker H (i.e., an example of hair) can be cut when outer net blade 211 is attached to electric razor 1, is formed in the central part of outer net blade member 30.

Cuttable region 31 is provided with many blade holes 33 that are each in a substantially hexagonal shape defined by bars 32 and are spread. As described above, blade hole 33 formed in outer net blade member 30 has a substantially hexagonal shape, so that reduction in efficiency of introduction of whisker H (i.e., an example of hair) facing blade hole 33 into blade hole 33 can be suppressed.

In the present exemplary embodiment, cuttable region 31 is provided with many blade holes 33 each in a substantially hexagonal shape defined by bars 32 in rows in the Y-direction (i.e., the first direction) and the X-direction (i.e., the second direction orthogonal to the first direction). At this time, as illustrated in FIG. 5, rows of blade holes 33 extending substantially in the X-direction (i.e., the second direction) are disposed side by side from one end 31a to other end 31b in the Y-direction (i.e., the first direction) of cuttable region 31. Similarly, rows of blade holes 33 extending substantially in the Y-direction (i.e., the first direction) are disposed side by side from one end 31c to other end 31d in the X-direction (i.e., the second direction) of cuttable region 31. As just described, cuttable region 31 includes many blade holes 33 that are each in a substantially hexagonal shape defined by bars 32 and that are spread.

In the present exemplary embodiment, a direction in which outer net blade 211 moves relative to inner net blade 212 when outer net blade 211 is provided on electric razor 1 is defined as the Y-direction (i.e., the first direction) of outer net blade members 30. A direction serves as a direction of shaving when outer net blade 211 is provided on electric razor 1 is defined as the X-direction (i.e., the second direction) of outer net blade member 30. Thus, in a state where outer net blade 211 is provided on electric razor 1, outer net blade 211 includes blade holes 33 that are aligned in the X-direction (i.e., the front-back direction, more specifically, the direction of shaving) and the Y-direction (i.e., the left-right direction, more specifically, the direction in which the inner net blade moves relative to the outer net blade).

In the present exemplary embodiment, each blade hole 33 is formed in a substantially hexagonal shape defined by a pair of first bars 321, a pair of second bars 322, and a pair of third bars 323.

Specifically, as illustrated in FIG. 6, the pair of first bars 321 extending in the Y-direction (i.e., the first direction) are disposed around one blade hole 33 in a state of being spaced apart from each other in the X-direction (i.e., the second direction). One of second bars 322 inclined with respect to the X-direction (i.e., the second direction) is provided continuously to an end of one of first bars 321 located closer to one end 31c in the X-direction (i.e., the second direction) than the other, the end being located on a side close to one end 31a in the Y-direction (i.e., the first direction). The other of second bars 322 inclined with respect to the X-direction (i.e., the second direction) is provided continuously to an end of the other of first bars 321 located closer to other end 31d in the X-direction (i.e., the second direction) than the one, the end being located on a side close to other end 31b in the Y-direction (i.e., the first direction).

One of third bars 323 inclined in a direction opposite to that of second bars 322 with respect to the X-direction (i.e., the second direction) is provided continuously to an end of the one of first bars 321 located closer to one end 31c in the X-direction (i.e., the second direction) than the other, the end being located on the side close to other end 31b in the Y-direction (i.e., the first direction), and to an end of the other of second bars 322. The other of third bars 323 inclined in the direction opposite to that of second bars 322 with respect to the X-direction (i.e., the second direction) is provided continuously to the end of the other of first bars 321 located closer to other end 31d in the X-direction (i.e., the second direction) than the one, the end being located on the side close to one end 31a in the Y-direction (i.e., the first direction), and to an end of the one of second bars 322.

As a result, blade hole 33 having a hexagonal shape that is point-symmetrical about the center of blade hole 33 is defined by the pair of first bars 321, the pair of second bars 322, and the pair of third bars 323.

As described above, in the present exemplary embodiment, bars 32 includes first bars 321 extending substantially parallel to the Y-direction (i.e., the first direction), second bars 322 connected to corresponding first bars 321, and third bars 323 connected to corresponding second bars 322, and substantially hexagonal blade hole 33 is defined by first bars 321, second bars 322, and third bars 323.

Blade hole 33 having such a shape includes an end in the Y-direction (i.e., the first direction) that is provided with corner 33a defined by a connection part between second bar 322 and third bar 323, corner 33a being capable of holding whisker H (i.e., an example of hair) introduced into blade hole 33 in a state of suppressing movement on skin.

When such corner 33a is provided at an end in the Y-direction (i.e., the first direction) in which inner net blade 212 relatively moves, whisker H (i.e., an example of hair) introduced into blade hole 33 can be cut by inner net blade 212 moving in the Y-direction (i.e., the first direction) in a state of being moved so as to be pushed into corner 33a. When whisker H (i.e., an example of hair) having been introduced into blade hole 33 and pushed into corner 33a is cut by inner net blade 212 moving in the Y-direction (i.e., the first direction), whisker H (i.e., an example of hair) can be cut shorter more reliably by being prevented from slipping (i.e., causing a skid) in the X-direction (the second direction) and being laid down. When whisker H (i.e., an example of hair) can be cut shorter more reliably by suppressing a skid of whisker H (i.e., an example of hair), stimulation to be applied to skin during use of electric razor 1 can be also reduced.

Further, in the present exemplary embodiment, first bars 321 are longer than second bars 322 and third bars 323. As a result, blade hole 33 in a hexagonal shape squeezed in the X-direction (i.e., the second direction) is formed.

In the present exemplary embodiment, second bar 322 is longer than third bar 323, and an inclination angle of second bar 322 with respect to the X-direction (i.e., the second direction) is larger than an inclination angle of third bar 323 with respect to the X-direction (i.e., the second direction). This allows one blade hole 33 to include corner 33a on the side close to one end 31a in the Y-direction (i.e., the first direction) and corner 33a on the side close to other end 31b in the Y-direction (i.e., the first direction), corners 33a being formed at respective positions shifted from each other in the X-direction (i.e., the second direction). At this time, the amount of the shift of two corners 33a in the X-direction (i.e., the second direction) is set to be ¼ or less of a length of blade hole 33 in the X-direction (i.e., the second direction).

Additionally, an angle of the connection part between second bar 322 and third bar 323, i.e., an angle of corner 33a, is set in a range from 135 degrees to 160 degrees inclusive. When corner 33a is formed with an obtuse angle as described above, stimulation to be applied to skin during use of electric razor 1 can be reduced, and whisker H (i.e., an example of hair) is prevented from being skidded.

In the present exemplary embodiment, no edge is formed on a peripheral edge of blade hole 33 when viewed in the Z-direction. In other words, corners (including corner 33a) formed at connection parts of the respective bars are rounded or substantially rounded. In this way, stimulation to skin during use of electric razor 1 is further reduced.

Further, in the present embodiment, multiple blade holes 33 in cuttable region 31 are each formed having a substantially identical shape. This allows introduction efficiency of whisker H (i.e., an example of hair) to be substantially equal in every blade hole 33, so that the introduction efficiency of whisker H (i.e., an example of hair) is prevented from varying depending on a position in cuttable region 31. That is, the introduction efficiency of whisker H (i.e., an example of hair) in cuttable region 31 is made more uniform.

When blade holes 33 are formed, bars 32 defining blade holes 33 are each substantially equal in thickness. In the present exemplary embodiment, bar 32 has a thickness of about 0.2 mm. This further improves an aperture ratio of blade holes 33 formed in cuttable region 31 and ensures strength of outer net blade member 30. That is, both the introduction efficiency of whisker H (i.e., an example of hair) and also the strength of outer net blade member 30 can be satisfied.

In the present exemplary embodiment, blade holes 33 are formed in rows in the X-direction (i.e., the second direction) in a state where the blade holes adjacent to each other in the X-direction (i.e., the second direction) are shifted from each other in position in the Y-direction (i.e., the first direction). In other words, rows extending in the X-direction are formed.

Specifically, two blade holes 33 adjacent to each other in the X-direction (i.e., the second direction) are formed such that blade hole 33 located on a side close to one end 31c in the X-direction (i.e., the second direction) is shifted toward other end 31b in the Y-direction (i.e., the first direction) with respect to blade hole 33 located on a side close to other end 31d in the X-direction (i.e., the second direction). As described above, in the present exemplary embodiment, blade holes 33 on one side (more specifically, the side close to one end 31c) in the X-direction (i.e., the second direction) are shifted from each other in one direction (more specifically, toward the side close to other end 31b) in the Y-direction (i.e., the first direction) with respect to blade holes 33 on the other side (more specifically, the side close to other end 31d) in the X-direction (i.e., the second direction).

In the present exemplary embodiment, blade holes 33 adjacent to each other in the X-direction (i.e., the second direction) are shifted from each other by almost the same amount (i.e., substantially the same amount) in the Y-direction (i.e., the first direction).

Thus, blade holes 33 exist at respective positions shifted toward one end 31a in the Y-direction (i.e., the first direction) by almost the same amount (i.e., substantially the same amount) with increasing distance from one end 31c toward other end 31d in the X-direction (i.e., the second direction), and thus, a row of blade holes 33 formed substantially in the X-direction (i.e., the second direction) extends toward other end 31d in the X-direction (i.e., the second direction) while being inclined toward one end 31a in the Y-direction (i.e., the first direction).

In the present exemplary embodiment, blade holes 33 are formed in rows in the Y-direction (i.e., the first direction) in a state where the blade holes adjacent to each other in the Y-direction (i.e., the first direction) are shifted from each other in position in the X-direction (i.e., the second direction). In other words, rows extending in the Y-direction are formed.

Specifically, in the present exemplary embodiment, two blade holes 33 adjacent to each other in the Y-direction (i.e., the first direction) are formed such that blade hole 33 located on the side close to one end 31a in the Y-direction (i.e., the first direction) is shifted toward one end 31c in the X-direction (i.e., the second direction) with respect to blade hole 33 located on the side close to other end 31b in the Y-direction (i.e., the first direction). As described above, blade holes 33 on one side (more specifically, the side close to one end 31a) in the Y-direction (i.e., the first direction) are shifted from each other in one direction (more specifically, toward the side close to one end 31c) in the X-direction (i.e., the second direction) with respect to blade holes 33 on the other side (more specifically, the side close to other end 31b) in the Y-direction (i.e., the first direction).

Additionally, in the present exemplary embodiment, blade holes 33 adjacent to each other in the Y-direction (i.e., the first direction) are shifted from each other by substantially the same amount in the X-direction (i.e., the second direction).

Thus, blade holes 33 exist at respective positions shifted toward other end 31d in the X-direction (i.e., the second direction) by almost the same amount with increasing distance from one end 31a toward other end 31b in the Y-direction (i.e., the first direction), and thus, a row of blade holes 33 formed substantially in the Y-direction (i.e., the first direction) extends toward other end 31b in the Y-direction (i.e., the first direction) and inclines toward other end 31d in the X-direction (i.e., the second direction).

As described above, in the present exemplary embodiment, multiple blade holes 33 are formed in cuttable region 31 in a state of being regularly arranged so as to form rows intersecting the Y-direction (i.e., the first direction) and the X direction (i.e., the second direction).

This configuration prevents the introduction efficiency of whisker H (i.e., an example of hair) from varying depending on a position in cuttable region 31. This also facilitates setting of positions of respective blade holes 33, and thus more facilitates manufacturing of outer net blade member 30.

When multiple blade holes 33 are formed so as to be regularly arranged forming rows intersecting the Y-direction (i.e., the first direction) and the X-direction (i.e., the second direction), corners 33a formed in respective blade holes 33 adjacent to each other in the X-direction (i.e., the second direction) are shifted from each other in the Y-direction (i.e., the first direction).

As described above, when corners 33a formed in respective blade holes 33 adjacent to each other in the X-direction (i.e., the second direction) are shifted from each other in the Y-direction (i.e., the first direction), whisker H (i.e., an example of hair) introduced into each of blade holes 33 adjacent to each other in the X-direction (i.e., the second direction) can be prevented from being cut simultaneously. As a result, not only a load on inner net blades 212 but also stimulation applied to skin during use of electric razor 1 can be reduced.

When multiple blade holes 33 are formed in a state of being regularly arranged so as to form rows intersecting the Y-direction (i.e., the first direction) and the X-direction (i.e., the second direction), first bars 321 defining respective blade holes 33 are shifted from each other in the X-direction (i.e., the second direction).

That is, when one (more specifically, blade hole 33 on the side close to one end 31a) of blade holes 33 adjacent to each other in the Y-direction (i.e., the first direction) is referred to as first blade hole 33C and the other (more specifically, blade hole 33 on the side close to other end 31b) is referred to as second blade hole 33D, first bars 321 defining first blade hole 33C are shifted toward one end 31c in the X-direction (i.e., the second direction) with respect to first bars 321 defining second blade hole 33D.

This configuration enables further reduction in variation in case of introduction into blade hole 33 depending on a length of whisker H (i.e., an example of hair).

For example, in a case where first bars 321 are aligned in a straight line in the Y-direction (i.e., the first direction) and where whisker H (i.e., an example of hair) having a certain length is less likely to be introduced into blade hole 33, whisker H (i.e., an example of hair) having the certain length is less likely to be introduced into any one of all of blade holes 33 aligned in the Y-direction (i.e., the first direction).

In contrast, even in a case where whisker H (i.e., an example of hair) having a certain length is less likely to be introduced into one of blade holes 33, when first bars 321 adjacent to each other in the Y-direction (i.e., the first direction) are shifted from each other in the X-direction (i.e., the second direction), whisker H (i.e., an example of hair) having the certain length can be easily introduced at a shifted position into the other blade hole 33. Additionally, even when whisker H (i.e., an example of hair) having another length is less likely to be introduced into other blade hole 33, whisker H (i.e., an example of hair) having the other length is easily introduced to the one blade hole 33 at a shifted position.

Thus, when first bars 321 are not arranged on a straight line in the Y-direction (i.e., the first direction), variation in case of introduction into blade hole 33 depending on a length of whiskers H (i.e., an example of hair) can be further reduced. That is, whisker H (i.e., an example of hair) different in length can be introduced into blade hole 33 more efficiently. As a result, whisker H (i.e., an example of hair) can be shaved more efficiently.

First bars 321 defining respective blade holes 33 are shifted from each other also in the Y-direction (i.e., the first direction).

That is, first bars 321 defining one (more specifically, blade hole 33 close to one end 31c) of blade holes 33 adjacent to each other in the X-direction (i.e., the second direction) are shifted toward other end 31b in the Y-direction (i.e., the first direction) with respect to first bars 321 defining the other (more specifically, blade hole 33 close to other end 31d).

This enables further reduction in variation in case of introduction into blade hole 33 depending on a length of whisker H (i.e., an example of hair), too.

For example, in a case where whisker H (i.e., an example of hair) having a certain length is less likely to be introduced into blade hole 33 and where first bars 321 are aligned at one position in the X-direction (i.e., the second direction), whisker H (i.e., an example of hair) having the certain length is less likely to be introduced into any one of all blade holes 33 aligned in the X-direction (i.e., the second direction). That is, blade holes 33 identical in shape exist at one position in the Y-direction (i.e., the first direction), so that whisker H (i.e., an example of hair) is not introduced into any of blade holes 33 during movement in the X-direction (i.e., the second direction), and thus may remain as unshaved whisker H (i.e., an example of hair).

In contrast, when first bars 321 adjacent to each other in the X-direction (i.e., the second direction) are shifted from each other in the Y-direction (i.e., the first direction), no blade hole 33 identical in shape exists at one position in the Y-direction (i.e., the first direction) during movement in the X-direction (i.e., the second direction). That is, introduction holes (more specifically, blade holes 33) various in shape exist in the X-direction (i.e., the second direction), so that possibility of introduction into any hole shape can be increased.

Thus, when first bars 321 are not aligned at one position in the X-direction (i.e., the second direction), variation in case of introduction into blade hole 33 depending on a length of whiskers H (i.e., an example of hair) can be further reduced. That is, whisker H (i.e., an example of hair) different in length can be introduced into blade hole 33 more efficiently. As a result, whisker H (i.e., an example of hair) can be shaved more efficiently.

Additionally, in the present embodiment, at least one of blade holes 33 exists at any position between one end 31a and other end 31b in the Y-direction (i.e., the first direction) in cuttable region 31 within a distance of five rows of the blade holes in the X-direction (i.e., the second direction).

This allows skin to face blade hole 33 within a distance of five rows of the blade holes when electric razor 1 is moved in the X-direction (i.e., the second direction), the skin being in contact with an outer surface of outer net blade 211 at any position between one end 31a and other end 31b in the Y-direction (i.e., the first direction) in cuttable region 31. That is, this prevents a region where the skin is in contact with only bars 32 defining blade hole 33 from existing when electric razor 1 is moved by the five rows of blade holes in the X-direction (i.e., the second direction) in a state where the skin is in contact with the outer surface of outer net blade 211.

As a result, even when whisker H (i.e., an example of hair) exists at any position on the skin in contact with the outer surface of outer net blade 211, whisker H (i.e., an example of hair) can face blade hole 33 within a distance of electric razor 1 by five rows of the blade holes in the X-direction (i.e., the second direction). That is, no whisker H (i.e., an example of hair) is prevented from being introduced into blade hole 33.

Thus, when electric razor 1 including outer net blade 211 formed by using outer net blade member 30 as described above is used, every whisker H (i.e., an example of hair) existing on the skin in contact with the outer surface of outer net blade 211 is given an opportunity to be introduced into blade hole 33 within a distance of movement of electric razor 1 on the skin by five rows of the blade holes in the X-direction (i.e., the second direction). As a result, whisker H (i.e., an example of hair) can be shaved more efficiently.

In general, a region of five rows of blade holes in the X-direction (i.e., the second direction) substantially corresponds to a region where skin comes into contact with an outer net blade obtained by curving an outer net blade member in a long plate shape in its latitudinal direction during the contact between the skin and the outer net blade.

Thus, in the present exemplary embodiment, blade holes 33 exist at all positions between one end 31a and other end 31b in the Y-direction (i.e., the first direction) in five rows of blade holes when viewed in the X-direction (i.e., the second direction), the five rows generally serving as a region with which the skin comes into contact.

When electric razor 1 including outer net blade 211 formed by curving outer net blade member 30 according to the present exemplary embodiment in its latitudinal direction is used, moving outer net blade 211 in contact with the skin in the X direction (i.e., the second direction) by one stroke (more specifically, five rows of blade holes) enables all of the skin in contact with outer net blade 211 to face blade holes 33.

As described above, when outer net blade member 30 according to the present exemplary embodiment is used, outer net blade 211 with which whisker H (i.e., an example of hair) can be shaved more efficiently can be formed.

Additionally, in the present embodiment, blade hole 33 exist at any position between one end 31a and other end 31b in the Y-direction (i.e., the first direction) in cuttable region 31, in a state where whiskers H (i.e., an example of hair) can be introduced into the blade hole, within a distance of five rows of the blade holes in the X-direction (i.e., the second direction).

Specifically, in the present embodiment, the skin faces blade hole 33 having an opening (more specifically, an opening having a region area equal to or larger than a cross-sectional area of the whisker) through which whisker H (i.e., an example of hair) can be introduced when electric razor 1 is moved in the X-direction (i.e., the second direction), the skin being in contact with the outer surface of outer net blade 211 at any position between one end 31a and other end 31b in the Y-direction (i.e., the first direction) in cuttable region 31. At this time, at least one blade holes 33 exists at every position between one end 31a and other end 31b in the Y-direction (i.e., the first direction) in five rows of the blade holes, each of blade holes 33 having a width (i.e., a length in the X-direction) of 0.12 mm or more, which is a normal thickness of whisker H (i.e., an example of hair).

As illustrated in FIG. 6, in the present exemplary embodiment, reference blade hole 33A and blade hole 33B overlap with each other, as viewed in the X-direction (i.e., the second direction). Here, reference blade hole 33A is a certain blade hole of multiple blade holes 33 formed in cuttable region 31. Blade hole 33B is adjacent in the Y-direction (i.e., the first direction) to a blade hole 33 which exists at a position moved from reference blade hole 33A by five rows of the blade holes in the X-direction (i.e., the second direction).

As just described, blade holes 33 are shifted from each other in position little by little in the Y-direction, so that blade hole 33 exist at every position between one end 31a and other end 31b in the Y-direction (i.e., the first direction) in five rows of the blade holes, blade hole 33 having a width (i.e., a length in the X-direction) of 0.12 mm or more, which is a normal thickness of whisker H (i.e., an example of hair).

As a result, whiskers H (i.e., an example of hair) that cannot have an opportunity to be introduced into blade hole 33 while facing blade hole 33 within a distance of five rows of the blade holes in the X-direction (i.e., the second direction) can be prevented from existing in the skin in contact with the outer surface of outer net blade 211. In other words, blade hole 33 without contributing to introduction of whiskers H (i.e., an example of hair) can be prevented from existing when electric razor 1 is used.

As a result, electric razor 1 with which whisker H (i.e., an example of hair) can be shave more efficiently is achievable.

As described above, in the present exemplary embodiment, bar 32 includes first bar 321 extending substantially parallel to the Y-direction (i.e., the first direction).

Thus, when electric razor 1 is moved in the X-direction (i.e., the second direction) in a state where the skin is in contact with the outer surface of outer net blades 211, whisker H (i.e., an example of hair) lying down can be raised more reliably by first bar 321.

As illustrated in FIG. 8, in the present exemplary embodiment, thickness T1 of first bar 321 is set smaller than thickness T2 of second bar 322 and thickness T3 of third bar 323. Specifically, step 32a is formed at a boundary between second bar 322 and first bar 321 and at a boundary between third bar 323 and first bar 321.

Thus, the reduction in thickness of first bar 321 having a function of raising whisker H (i.e., an example of hair) lying down enables first bar 321 to more easily slide into under whisker H (i.e., an example of hair) lying down when electric razor 1 is moved in the X-direction (i.e., the second direction) in a state where the skin is in contact with the outer surface of outer net blades 211. As a result, whisker H (i.e., an example of hair) lying down can be raised more reliably by first bar 321, and thus whisker H (i.e., an example of hair) can be shaved more efficiently.

### [Operation and Effect]

Hereinafter, characteristic configurations and effects obtained thereby of the outer net blade member, the outer net blade formed using the outer net blade member, and the electric razor including the outer net blade described in the above exemplary embodiment will be described.

### (Technique 1)

Outer net blade member 30 described in the exemplary embodiment above is capable of forming outer net blade 211 provided in electric razor 1. Outer net blade member 30 includes cuttable region 31 where whisker H (i.e., an example of hair) can be cut by outer net blade 211 provided on electric razor 1.

Cuttable region 31 is provided with many blade holes 33 each in a substantially hexagonal shape defined by bars 32 in rows in the Y-direction (i.e., the first direction) and the X-direction (i.e., the second direction orthogonal to the first direction).

Here, the Y-direction (i.e., the first direction) is a direction in which inner net blade 212 moves relative to outer net blade 211 when outer net blade 211 is provided on electric razor 1. The X-direction (i.e., the second direction) is a direction of shaving when outer net blade 211 is provided on electric razor 1.

Blade holes 33 are formed in rows in the X-direction (i.e., the second direction) in a state where the blade holes adjacent to each other in the X-direction (i.e., the second direction) are shifted from each other in position in the Y-direction (i.e., the first direction).

At any position between one end 31a and other end 31b in the Y-direction (i.e., the first direction) in cuttable region 31, at least one of blade holes 33 exists within a distance of five rows of the blade holes in the X-direction (i.e., the second direction).

When outer net blade 211 formed using outer net blade member 30 including blade holes 33 as described above is provided on electric razor 1, electric razor 1 with which whisker H (i.e., an example of hair) can be shaved more efficiently can be obtained.

For example, when electric razor 1 including outer net blade 211 formed by using outer net blade member 30 described in the exemplary embodiment above is moved in the X-direction (i.e., the second direction) in a state where the skin is in contact with the outer surface of outer net blade 211, the skin in contact with the outer surface of outer net blade 211 at any position between one end 31a and other end 31b in the Y-direction (i.e., the first direction) in cuttable region 31 faces blade hole 33 within a distance of five rows of the blade holes. That is, this prevents a region where the skin is in contact with only bars 32 defining blade hole 33 from existing when electric razor 1 is moved by the five rows of blade holes in the X-direction (i.e., the second direction) in a state where the skin is in contact with the outer surface of outer net blade 211.

As a result, even when whisker H (i.e., an example of hair) exists at any position on the skin in contact with the outer surface of outer net blade 211, whisker H (i.e., an example of hair) can face blade hole 33 within a distance of electric razor 1 by five rows of the blade holes in the X-direction (i.e., the second direction). That is, no whisker H (i.e., an example of hair) is allowed to be prevented from being introduced blade hole 33.

As described above, when electric razor 1 including outer net blade 211 formed by using outer net blade member 30 shown in the exemplary embodiment above is used, every whisker H (i.e., an example of hair) existing on the skin in contact with the outer surface of outer net blade 211 is given an opportunity to be introduced into blade hole 33 within a distance of movement of electric razor 1 by five rows of the blade holes in the X-direction (i.e., the second direction).

Blade hole 33 formed in outer net blade member 30 shown in the exemplary embodiment above has a substantially hexagonal shape, so that reduction in introduction efficiency of whisker H (i.e., an example of hair) facing blade hole 33 into blade hole 33 can be suppressed.

Thus, electric razor 1 including outer net blade 211 formed by using outer net blade member 30 shown in the exemplary embodiment above enables more efficient shaving of whisker H (i.e., an example of hair).

As described above, when outer net blade member 30 according to the exemplary embodiment above is used, outer net blade 211 capable of more efficiently shaving whisker H (i.e., an example of hair) can be formed.

### (Technique 2)

In (Technique 1) described above, at any position between one end 31a and other end 31b in the Y-direction (i.e., the first direction) in cuttable region 31, the at least one of blade holes 33 may exist within the distance of the five rows of the blade holes in the X-direction (i.e., the second direction) in a state where whiskers H (i.e., an example of hair) can be introduced into the at least one of the blade holes 33.

For example, in (Technique 2), the skin can face blade hole 33 having an opening (more specifically, an opening having a region area equal to or larger than a cross-sectional area of the whisker) through which whisker H (i.e., an example of hair) can be introduced when electric razor 1 is moved in the X-direction (i.e., the second direction), the skin being in contact with the outer surface of outer net blade 211 at any position between one end 31a and other end 31b in the Y-direction (i.e., the first direction) in cuttable region 31.

As a result, whiskers H (i.e., an example of hair) that cannot have an opportunity to be introduced into blade hole 33 while facing blade hole 33 within a distance of five rows of the blade holes in the X-direction (i.e., the second direction) can be prevented from existing in the skin in contact with the outer surface of outer net blade 211. In other words, blade hole 33 without contributing to introduction of whiskers H (i.e., an example of hair) can be reliably prevented from existing when electric razor 1 is used.

As a result, electric razor 1 capable of more efficiently shaving whisker H (i.e., an example of hair) is achievable.

### (Technique 3)

In (Technique 1) or (Technique 2) described above, multiple blade holes 33 formed in cuttable region 31 may be substantially identical in shape.

This enables introduction efficiency of whisker H (i.e., an example of hair) into every blade hole 33 to be substantially equal. As a result, the introduction efficiency of whisker H (i.e., an example of hair) can be prevented from varying depending on a position in cuttable region 31. That is, the introduction efficiency of whisker H (i.e., an example of hair) in cuttable region 31 can be made more uniform.

### (Technique 4)

In any one of (Technique 1) to (Technique 3), blade hole 33 on one side in the X-direction (i.e., the second direction) may be shifted in one direction in the Y-direction (i.e., the first direction) with respect to blade hole 33 on the other side in the X-direction (i.e., the second direction).

This enables multiple blade holes 33 to be regularly arranged, and thus enables suppressing variation in the introduction efficiency of whisker H (i.e., an example of hair) depending on a position in cuttable region 31. When multiple blade holes 33 are regularly arranged, position setting of blade holes 33 is facilitated to enable manufacturing of the blade holes to be more facilitated.

### (Technique 5)

In any one of (Technique 1) to (Technique 4) described above, blade holes 33 adjacent to each other in the X-direction (i.e., the second direction) may be shifted from each other in the Y-direction (i.e., the first direction) by a substantially equal amount.

This enables multiple blade holes 33 to be more regularly arranged, and thus enables suppressing variation in the introduction efficiency of whisker H (i.e., an example of hair) depending on a position in cuttable region 31. When multiple blade holes 33 are regularly arranged, position setting of blade holes 33 is facilitated to enable manufacturing of the blade holes to be more facilitated.

(Technique 6) Any one of the (Technique 1) to (Technique 5) described above may be configured such that reference blade hole 33A and blade hole 33B overlap with each other when viewed in the X-direction (i.e., the second direction). Here, blade hole 33B is adjacent in the Y-direction (i.e., the first direction) to blade hole 33 which exists at a position located five rows of blade holes 33 in the X-direction (i.e., the second direction) away from reference blade hole 33A. Reference blade hole 33A is a certain blade hole of blade holes 33 formed in the cuttable region 31.

This enables multiple blade holes 33 to be regularly arranged, and thus enables suppressing variation in the introduction efficiency of whisker H (i.e., an example of hair) depending on a position in cuttable region 31. When multiple blade holes 33 are regularly arranged, position setting of blade holes 33 is facilitated to enable manufacturing of the blade holes to be more facilitated.

### (Technique 7)

In any one of (Technique 1) to (Technique 6) described above, bars 32 may include first bars 321 extending substantially parallel to the Y-direction (i.e., the first direction).

This enables whisker H (i.e., an example of hair) lying down to be raised more reliably by first bars 321 when electric razor 1 is moved in the X-direction (i.e., the second direction) in a state where the skin is in contact with the outer surface of outer net blades 211, and thus enables whiskers H (i.e., an example of hair) to be shaved more efficiently.

### (Technique 8)

In (Technique 7) described above, first bars 321 defining a first blade hole 33C and first bars 321 defining a second blade hole 33D may be shifted from each other in the X-direction (i.e., the second direction). Here, first blade hole 33C is one of two of the plurality of the blade holes 33 adjacent to each other in the Y-direction (i.e., in the first direction), and the second blade hole 33D is the other one of the two of the plurality of the blade holes 33 adjacent to each other in the Y-direction (i.e., in the first direction).

This enables further reduction in variation in case of introduction into blade hole 33 depending on a length of whisker H (i.e., an example of hair).

For example, in a case where whisker H (i.e., an example of hair) having a certain length is less likely to be introduced into blade hole 33 and where first bars 321 are aligned in a straight line in the Y-direction (i.e., the first direction), whisker H (i.e., an example of hair) having the certain length to be less likely to be introduced into any one of blade holes 33 aligned in the Y-direction (i.e., the first direction).

In contrast, even in a case where whisker H (i.e., an example of hair) having a certain length and being less likely to be introduced into one of blade holes 33, when first bars 321 adjacent to each other in the Y-direction (i.e., the first direction) are shifted from each other in the X-direction (i.e., the second direction), whiskers H (i.e., an example of hair) having the certain length can be easily introduced into the other blade hole 33 at a shifted position. Additionally, even in a case where whisker H (i.e., an example of hair) having another length is less likely to be introduced into other blade hole 33, whiskers H (i.e., an example of hair) having the other length can be easily introduced into the one blade hole 33 at a shifted position.

Thus, when first bars 321 are not arranged on a straight line in the Y-direction (i.e., the first direction), variation in case of introduction into blade hole 33 depending on a length of whiskers H (i.e., an example of hair) can be further reduced. That is, whisker H (i.e., an example of hair) different in length can be introduced into blade hole 33 more efficiently. As a result, whisker H (i.e., an example of hair) can be shaved more efficiently.

### (Technique 9)

In (Technique 7) or (Technique 8) described above, bars 32 may include second bar 322 connected to first bar 321 and third bar 323 connected to second bar 322. Blade hole 33 may be provided at its end in the Y-direction (i.e., the first direction) with corner 33a capable of holding whisker H (i.e., an example of hair) introduced into blade hole 33 in a state where whisker H (i.e., an example of hair) introduced into blade hole 33 is prevented from being moved on skin. Corner 33a may be formed at a connection part between second bar 322 and third bar 323.

This configuration enables whisker H (i.e., an example of hair) introduced into blade hole 33 to be cut by inner net blade 212 moving in the Y-direction (i.e., the first direction) in a state of being moved so as to be pushed into corner 33a. When whisker H (i.e., an example of hair) which has been introduced into blade hole 33 and pushed into corner 33a is cut by inner net blade 212 moving in the Y-direction (i.e., the first direction) as described above, whisker H (i.e., an example of hair) can be cut shorter more reliably by being prevented from slipping (i.e., causing a skid) in the X-direction (i.e., the second direction) and being laid down.

When whisker H (i.e., an example of hair) can be cut shorter more reliably by suppressing a skid of whisker H (i.e., an example of hair), stimulation to be applied to skin during use of electric razor 1 can be also reduced.

### (Technique 10)

In (Technique 9) described above, corners 33a formed in blade holes 33 adjacent to each other in the X-direction (i.e., the second direction) may be shifted from each other in the Y-direction (i.e., the first direction).

This prevents whisker H (i.e., an example of hair) introduced into each of blade holes 33 adjacent to each other in the X-direction (i.e., the second direction) from being cut simultaneously, so that not only a load on inner net blades 212 but also stimulation applied to skin during use of electric razor 1 can be reduced.

### (Technique 11)

In (Technique 9) or (Technique 10) described above, thickness T1 of first bar 321 may be smaller than thickness T2 of second bar 322 and thickness T3 of third bar 323.

This enables first bar 321 to more easily slide into under whisker H (i.e., an example of hair) lying down when electric razor 1 is moved in the X-direction (i.e., the second direction) in a state where the skin is in contact with the outer surface of outer net blades 211. As a result, whisker H (i.e., an example of hair) lying down can be raised more reliably by first bar 321, and thus whisker H (i.e., an example of hair) can be shaved more efficiently.

(Technique 12) Outer net blade 211 shown in the exemplary embodiment above is formed using outer net blade member 30 disclosed in any one of (Technique 1) to (Technique 11).

When outer net blade 211 is formed using outer net blade member 30 as described above, whisker H (i.e., an example of hair) can be shaved more efficiently with outer net blade 211.

(Technique 13) Electric razor 1 shown in the exemplary embodiment above includes outer net blade 211 disclosed in (Technique 12) described above.

In this way, electric razor 1 with which hair can be shaved more efficiently is obtained.

### [Others]

Although the contents of the outer net blade member, the outer net blade formed using the outer net blade member, and the electric razor including the outer net blade according to the present disclosure have been described above, the present disclosure is not limited to these descriptions, and it is obvious to those skilled in the art that various modifications and improvements can be made.

For example, the present disclosure can be applied to exemplary embodiments in which changes, replacements, additions, omissions, and the like of the configurations described in the exemplary embodiments are made. Alternatively, the components described in the above exemplary embodiments may be combined to make an additional exemplary embodiment.

Although the exemplary embodiment above exemplifies electric razor 1 including grip part 11 and head part 12, the present disclosure is also applicable to an electric razor without a head part. In this case, a blade unit is supported by a part of a razor body, the part corresponding to a body part.

Blade unit 20 may include two blade blocks, or blade unit 20 may include four or more blade blocks. Even in such a case, an alignment sequence of each blade block can be appropriately set.

In the exemplary embodiment above, outer net blade member 30 in which blade holes 33 arranged regularly are formed in cuttable region 31 is exemplified. However, blade holes 33 disposed randomly may be formed in cuttable region 31, or blade hole 33 different in size may exist.

Although the exemplary embodiment above exemplifies electric razor 1 of a reciprocating type, the present disclosure is also applicable to an electric razor of a rotating type. In this case, a circumferential direction serves as the first direction, and a radial direction serves as the second direction. Additionally, any points in the circumferential direction serve as one end in the first direction and the other end in the first direction, an outer peripheral end serves as one end in the second direction, and the center of rotation serves as the other end in the second direction.

Specifications (e.g., shape, size, and layout) of the blade block, the razor body, and other details can also be changed as appropriate.

As described above, the outer net blade member, the outer net blade formed using the outer net blade member, and the electric razor including the outer net blade according to the present disclosure can shave hair more efficiently, and thus can be applied to application of treatment not only to a whisker but also to various body hairs, for example.

What is claimed is:

1. An outer net blade member that forms an outer net blade provided on an electric razor, the outer net blade member comprising:
a cuttable region configured to cut hair in a state where the outer net blade is provided on the electric razor,
wherein
in the cuttable region, a plurality of blade holes that are each in a substantially hexagonal shape defined by bars are formed in a state of forming rows in a first direction and in a second direction which is orthogonal to the first direction,
the first direction is a direction in which an inner net blade moves relative to the outer net blade when the outer net blade is provided on the electric razor,
the second direction is a direction of shaving when the outer net blade is provided on the electric razor,
the plurality of the blade holes are formed in such a manner that two of the plurality of the blade holes adjacent in the second direction form a row in the second direction in a state where the two of the plurality of the blade holes are shifted from each other in position in the first direction, and
at any position between one end and other end in the first direction in the cuttable region, at least one of the plurality of the blade holes exists within a distance of five rows of the plurality of the blade holes in the second direction.

2. The outer net blade member according to claim 1, wherein
at any position between the one end and the other end in the first direction in the cuttable region, the at least one of the plurality of the blade holes exists within the distance of the five rows of the plurality of the blade holes in the second direction in a state where the hair is allowed to be introduced into the at least one of the plurality of the blade holes.

3. The outer net blade member according to claim 1, wherein
the plurality of the blade holes formed in the cuttable region are substantially identical in shape.

4. The outer net blade member according to claim 3, wherein
a blade hole on one side in the second direction is shifted in one direction in the first direction with respect to a blade hole on another side in the second direction.

5. The outer net blade member according to claim 4, wherein
the two of the plurality of the blade holes adjacent to each other in the second direction are shifted from each other in the first direction by a substantially equal amount.

6. The outer net blade member according to claim 5, wherein
a reference blade hole and a blade hole which is adjacent in the first direction to a blade hole which exists at a position located five rows of the plurality of the blade holes in the second direction away from the reference blade hole overlap with each other when viewed in the second direction,
where
the reference blade hole is a certain blade hole of the plurality of the blade holes formed in the cuttable region.

7. The outer net blade member according to claim 1, wherein
the bars include first bars extending substantially parallel to the first direction.

8. The outer net blade member according to claim 7, wherein
the first bars defining a first blade hole and the first bars defining a second blade hole are shifted from each other in the second direction,
the first blade hole is one of two of the plurality of the blade holes adjacent to each other in the first direction, and
the second blade hole is the other one of the two of the plurality of the blade holes adjacent to each other in the first direction.

9. The outer net blade member according to claim 7, wherein
the bars comprise:
a second bar connected to corresponding one of the first bars; and
a third bar connected to the second bar,
each of the plurality of the blade holes includes an end in the first direction, the end being provided with a corner that holds hair introduced into the blade hole in a state where movement of the hair is suppressed, and
the corner is formed at a connection part between the second bar and the third bar.

10. The outer net blade member according to claim 9, wherein
the corner constitutes corners formed in the two of the plurality of the blade holes adjacent to each other in the second direction, the corners being shifted from each other in the first direction.

11. The outer net blade member according to claim 9, wherein
a thickness of each of the first bars is smaller than a thickness of each of the second bar and the third bar.

12. An outer net blade formed using the outer net blade member according to claim 1.

13. An electric razor comprising the outer net blade according to claim 1.
